(19) United States
(12) Patent Application Publication
(10) Pub. No.: US 2019/0208712 A1
(43) Pub. Date: Jul. 11, 2019

(54) GROWING METHODS FOR PLANTS IN CONTAINERS

(71) Applicant: Elie Gendloff, Vista, CA (US)

(72) Inventor: Elie Gendloff, Vista, CA (US)

(21) Appl. No.: 16/240,770

(22) Filed: Jan. 6, 2019

Related U.S. Application Data
(60) Provisional application No. 62/614,480, filed on Jan. 7, 2018.

(51) Int. Cl. A01G 9/02; A01G 27/02

(52) U.S. Cl. CPC A01G 9/024; A47G 7/041; A01G 27/02

(57) ABSTRACT

Provided is a method of growing a plant in a container, wherein the container comprises an open top rim, closed rigid sides, a closed lower surface, and a hole through the lower surface, wherein the container can hold a medium suitable for growing a plant therein. The method comprises suspend the container above a closed bottom surface of a floodable vessel, and, intermittently, flood the vessel with a fluid to a first fluid level such that the lower surface of the container is immersed in the fluid, then drain the vessel such that the fluid (a) is at a level below the lower surface of the container or (b) completely leaves the vessel.

In other embodiments, the method comprises a system for growing a plant in a container. The system comprises the vessel in the above-identified method.

### CROSS-REFERENCE TO RELATED APPLICATIONS

This application claims the benefit of U.S. Provisional Application No. 62/614,480, filed Jan. 7, 2018, and incorporated by reference herein in its entirety.

### BACKGROUND OF THE INVENTION

### (1) Field of the Invention

The present application generally relates to methods of growing plants using hydroponics. More specifically, the application is directed to methods of growing a plant in a container where the container is suspended above a floodable vessel.

### (2) Description of the Related Art

US Patent Publication 2016/0219795 (incorporated by reference) describes edible plants growing in a container in solid medium or a solid mixture of porous media. That publication describes growing the plants in a flood table or on a bench surface on top of absorbent material that gets wet from drip tubes below the absorbent material, so that the plants are watered through holes in the bottom of the container. These plants, having a media that does not fall out of the container when tipped over, are ideal to serve alive, for example using the methods described in US Patent Publications 2014/0279714 and 2014/0279715, both incorporated by reference.

The present invention is directed to an improved method of growing those plants or other container grown plants.

### BRIEF SUMMARY OF THE INVENTION

Provided is a method of growing a plant in a container, wherein the container comprises an open top rim, closed rigid sides, a closed lower surface, and a hole through the lower surface, wherein the container can hold a medium suitable for growing a plant therein. The method comprises suspend the container above a closed bottom surface of a floodable vessel, and, intermittently, flood the vessel with a fluid to a first fluid level such that the lower surface of the container is immersed in the fluid, then drain the vessel such that the fluid (a) is at a level below the lower surface of the container or (b) completely leaves the vessel.

In other embodiments, the method comprises a system for growing a plant in a container. The system comprises the vessel in the above-identified method.

### BRIEF DESCRIPTION OF THE SEVERAL VIEWS OF THE DRAWINGS

FIG. 1 illustrates an exemplary embodiment of the invention.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

The plant growing methods described in US Patent Publication 2016/0219795 uses a flood table or a bench that often, particularly at the early stages of growth, has open areas between the plants, promoting algae growth. Under those conditions, the flood table or bench must be cleaned of algae after each crop. Also since the plants grown on the flood table or bench are sitting on a surface and watered from below, roots tend to grow out of the holes in the bottom of the container since the flood table or bench surface below the container remains wet after watering, particularly in the later stages of growth, or if the container is small relative to the size of the plant. When the container is moved, e.g., to be packaged or consumed, some of the roots are often left behind since they often adhere to the surface of the flood table or bench.

The present invention provides improvements to the methods described in US Patent Publication 2016/0219795. Those improvements prevent the exposure of a wet bench or flood table to light, thus preventing algae growth, and avoid the constant dampness under the container, thus inhibiting root growth through holes in the bottom of the container.

Thus, in some embodiments, a method of growing a plant in a container is provided. The container in these methods comprises an open top rim, closed rigid sides, a closed lower surface, and a hole through the lower surface. The container can hold a medium suitable for growing a plant. The method comprises suspend the container above a closed bottom surface of a floodable vessel, and, intermittently, flood the vessel with a fluid to a first fluid level such that the lower surface of the container is immersed in the fluid, then drain the vessel such that the fluid (a) is at a level below the lower surface of the container or (b) completely leaves the vessel.

In some of these embodiments, after the vessel is drained of the fluid, air or gas (e.g., nitrogen gas) is directed to the space between the bottom of the container and the closed bottom surface, to dry the container bottom, so as to further prevent roots from growing out of the container bottom. The air can be so directed by any means known in the art, e.g., a fan or an air jet.

In these embodiments, the container can be any container suitable for growing plants. In some embodiments, the container is constructed of rigid plastic. In other embodiments, the container is constructed of terracotta, glazed ceramic and/or wood. The container can also be any size or shape, e.g., round, square, etc. and of any diameter, e.g., 1 inch to 8 inches. In some embodiments, the container is square at the top and is from 2 inches to 5 inches on a side. In particular embodiments, the container is rigid plastic, square along the top, and 2″ in diameter.

The invention is also not narrowly limited to any particular growth medium. In some embodiments, the medium is a potting soil. In other embodiments, the medium is a solid medium or solid mixture of porous media. Non-limiting examples of solid media include a mineral wool, for example made of glass, ceramic or stone, e.g., stone wool fiber such as rock wool, or a plastic foam such as HORTICUBE®, ROOTCUBE® or WEDGE®. In some embodiments, the plant is growing in a solid mixture of porous medium. Such solid mixture can include any natural or artificial material that is not toxic to plants. Nonlimiting examples include soil, vermiculite, perlite, peat, mixtures comprising coconut shell, sand, and clay. The porous mixture can be held together by any means known in the art, e.g., paper or plastic netting.

The fluid can be any fluid that supports plant growth. In some embodiments, the fluid is water or a fertilizer solution.

The plant can be any known plant that is capable of growing in the container. In some embodiments, the plant is an edible plant. Non-limiting examples include tomato, pepper, bean, green onion, chive, leek, pea, cauliflower, Brussels sprouts, celery, horseradish, asparagus, kale, sorrel, endive, spinach, lettuce, arugula, cabbage, bok choy, mustard, Swiss chard, basil, rosemary, thyme, cilantro, bay, dill, fennel, marjoram, mint, chamomile, oregano, parsley, sage, savory, tarragon, chervil, dill, spearmint, watercress, lemon balm, rosemary, thyme, an edible flower, alfalfa sprouts, bean sprouts, quinoa sprouts, chia sprouts, white mushroom, shiitake mushroom, cremini mushroom, oyster mushroom, portabella mushroom, and truffle.

In various embodiments, only one plant is growing in the container.

These methods are not limited to any particular way of suspending the container, nor are they limited to any particular vessel configuration, or procedure to flood and drain the vessel.

In some embodiments, the vessel comprises a fluid inlet port and a fluid outlet port, wherein both the inlet port and the outlet port each comprise a hole through the closed bottom surface. In some of these embodiments, an inlet tube extends from the inlet port outside the vessel to a fluid source and an outlet tube extends from the outlet port outside the vessel to a drainage destination. In these embodiments, a fluid level tube extends into the vessel from the outlet port to an inner end of the fluid level tube, at a distance above the vessel bottom surface equivalent to the fluid level such that, when the vessel is flooded through the inlet port, the fluid rises to the top of the fluid level tube and spills into the inner end of the fluid level tube and through the drainage tube to the drainage destination.

In some aspects of these embodiments, the fluid source and the drainage destination are a common reservoir. In some of these aspects, the reservoir further comprises a pump connected to an end of the inlet tube distal to the vessel wherein, when the pump is activated, it pumps the fluid through the inlet tube through the inlet port into the vessel, flooding the vessel, and wherein, when the pump is deactivated after flooding the vessel, fluid from the reservoir can pass back through the inlet port, the inlet tube and the pump, into the reservoir.

These embodiments are not limited to any particular shape or type of reservoir or any particular type of pump, provided the pump allows backflow of the fluid from the vessel when the pump is not activated.

In some of these methods, the vessel is a cylinder that lies horizontally, with closed sides and openings or a slit along an uppermost side wider than the diameter of the container bottom surface.

The cylinder can be of any shape or material provided the sides are closed to allow the vessel to be flooded.

In some of these embodiments, the cylinder has a slit along the uppermost side that is narrower than the diameter top rim of the container, such that, when a container is placed in the slit, the container is suspended in the slit above the bottom of the cylinder.

In other of embodiments, the cylinder has holes along the uppermost side that are each narrower than the diameter top rim of the container, such that, when the container is placed in one of the holes, the container is suspended in the hole above the bottom of the cylinder.

In additional embodiments, the cylinder has a slit along the uppermost side that is wider than the top rim of the container. These embodiments further comprise a mechanism to suspend the container within the slit, e.g., hooks, netting, cross-bars, brackets, etc. In some embodiments, the method further comprises placing the container into a holder then placing the holder on the slit such that the container is suspended in the holder on the slit above the bottom of the container. In these embodiments, the holder is a plate wider on all sides than the slit, the plate further comprising a hole having a diameter wider than the diameter of the container bottom surface and narrower than the top rim of the container, wherein the container is inserted into the hole.

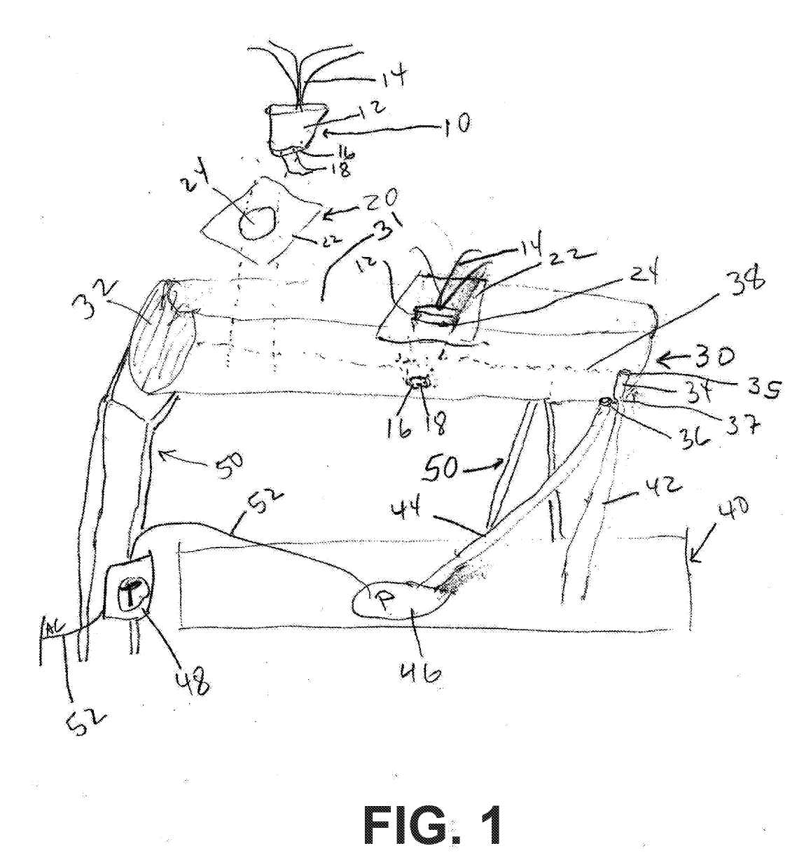

A non-limiting example of these embodiments is illustrated in FIG. 1. The plant growing in the container 10 comprises a plant 14 growing in a medium in the container 12. The lower surface of the container 16 comprises holes 18 that allow the fluid to enter the container.

The container 12 is inserted into a holder 20, which comprises a plate 22 and a hole 24, into which the plant is placed.

The holder-container combination is placed on a slit 31 cut into a cylinder/vessel 30 that has closed sides 32. The vessel, deployed on a support 50, also has an inlet port 36 and outlet port 28, from which an inlet tube 44 and an outlet tube 42, respectively, extends from the bottom of the respective port 36 and 38. A fluid level tube 34 also extends into the cylinder/vessel 30. The top of the fluid level tube 35 maintains the fluid level 38 at that height. Both the inlet tube 44 and the outlet tube 42 go into a reservoir 40, where the fluid is stored. The inlet tube 44 is connected to a pump 46, the activation of which is controlled by a timer 48 connected to the pump 46 by an electrical cord 52. The timer is also connected to an AC circuit by an electrical cord 52.

In other embodiments, the vessel is a tub having a top edge. The tub further comprises cross-bars, where the distance between the cross-bars is greater than the diameter of the container bottom surface, so that the container can be placed between the cross-bars.

In some aspects of these embodiments, the distance between the cross-bars is less than the diameter of the top rim of the container, such that, when the container is placed between the cross-bars, the container is suspended above the bottom of the cylinder. In other aspects of these embodiments, the distance between the cross-bars is greater than the diameter of the top rim of the container, and the container is suspended between the cross-bars by any mechanism known in the art, e.g., hooks, netting, cross-bars, brackets, etc. In some embodiments, the method further comprises placing the container into a holder then placing the holder over the cross-bars such that the container is suspended in the holder through the cross-bars above the bottom of the container. In these embodiments, the holder is a plate wider on all sides than the distance between the cross-bars, the plate further comprising a hole having a diameter wider than the diameter of the container bottom surface and narrower than the top rim of the container, wherein the container is inserted into the hole.

The present invention is also directed to a system for growing a plant in a container. The system comprises any embodiments of the above-described vessel. In some embodiments, the system further comprises the above-described holder and/or any of the other components used in the above methods.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A method of growing a plant in a container, wherein
the container comprises an open top rim, closed rigid sides, a closed lower surface, and a hole through the lower surface, wherein the container can hold a medium suitable for growing a plant therein,
the method comprising
suspend the container above a closed bottom surface of a floodable vessel, and, intermittently,
flood the vessel with a fluid to a first fluid level such that the lower surface of the container is immersed in the fluid, then drain the vessel such that the fluid (a) is at a level below the lower surface of the container or (b) completely leaves the vessel.

2. The method of claim 1, wherein the vessel comprises a fluid inlet port and a fluid outlet port, wherein both the inlet port and the outlet port each comprise a hole through the closed bottom surface, wherein
an inlet tube extends from the inlet port outside the vessel to a fluid source;
an outlet tube extends from the outlet port outside the vessel to a drainage destination;
a fluid level tube extends into the vessel from the outlet port to an inner end of the fluid level tube, at a distance above the vessel bottom surface equivalent to the fluid level such that, when the vessel is flooded through the inlet port, the fluid rises to the top of the fluid level tube and spills into the inner end of the fluid level tube and through the drainage tube to the drainage destination.

3. The method of claim 2, wherein
the fluid source and the drainage destination are a common reservoir;
the reservoir further comprises a pump connected to an end of the inlet tube distal to the vessel wherein, when the pump is activated, it pumps the fluid through the inlet tube through the inlet port into the vessel, flooding the vessel,
wherein, when the pump is deactivated after flooding the vessel, fluid from the reservoir can pass back through the inlet port, the inlet tube and the pump, into the reservoir.

4. The method of claim 2, wherein the fluid is water or an aqueous fertilizer solution.

5. The method of claim 1, wherein the vessel is a cylinder that lies horizontally, with closed sides and openings or a slit along an uppermost side wider than the diameter of the container bottom surface.

6. The method of claim 5, wherein the cylinder has a slit along the uppermost side that is narrower than the diameter top rim of the container, such that, when a container is placed in the slit, the container is suspended in the slit above the bottom of the cylinder.

7. The method of claim 5, wherein the cylinder has holes along the uppermost side that are each narrower than the diameter top rim of the container, such that, when the container is placed in one of the holes, the container is suspended in the hole above the bottom of the cylinder.

8. The method of claim 5, wherein the cylinder has a slit along the uppermost side that is wider than the top rim of the container,
the method further comprising placing the container into a holder then placing the holder on the slit such that the container is suspended in the holder on the slit above the bottom of the container,
wherein the holder is a plate wider on all sides than the slit, the plate further comprising a hole having a diameter wider than the diameter of the container bottom surface and narrower than the top rim of the container, wherein the container is inserted into the hole.

9. The method of claim 5, wherein the vessel is a tub having a top edge, the tub further comprising cross-bars, wherein the distance between the cross-bars is greater than the diameter of the container bottom surface.

10. The method of claim 9, wherein the distance between the cross-bars is less than the diameter of the top rim of the container, such that, when the container is placed between the cross-bars, the container is suspended above the bottom of the cylinder.

11. The method of claim 9, wherein the distance between the cross-bars is greater than the diameter of the top rim of the container,
the method further comprising placing the container into a holder then placing the holder over the cross-bars such that the container is suspended in the holder through the cross-bars above the bottom of the container,
wherein the holder is a plate wider on all sides than the distance between the cross-bars, the plate further comprising a hole having a diameter wider than the diameter of the container bottom surface and narrower than the top rim of the container, wherein the container is inserted into the hole.

12. The method of claim 1, wherein only one plant is in the container.

13. The method of claim 1, wherein the plant is an edible plant.

14. The method of claim 13, wherein the edible plant is tomato, pepper, bean, green onion, chive, leek, pea, cauliflower, Brussels sprouts, celery, horseradish, asparagus, kale, sorrel, endive, spinach, lettuce, arugula, cabbage, bok choy, mustard, Swiss chard, basil, rosemary, thyme, cilantro, bay, dill, fennel, marjoram, mint, chamomile, oregano, parsley, sage, savory, tarragon, chervil, dill, spearmint, watercress, lemon balm, rosemary, thyme, an edible flower, alfalfa sprouts, bean sprouts, quinoa sprouts, chia sprouts, white mushroom, shiitake mushroom, cremini mushroom, oyster mushroom, portabella mushroom, or truffle.

15. The method of claim 13, wherein the edible plant is lettuce or basil.

16. The method of claim 1, wherein the medium is a porous, solid medium or a solid mixture of porous media.

17. A system for growing a plant in a container, the system comprising the vessel of claim 1.
